(19) United States
(12) Patent Application Publication
(10) Pub. No.: US 2025/0164623 A1
(43) Pub. Date: May 22, 2025

(54) LIDAR-Camera System

(71) Applicant: Shenzhen Yinwang Intelligent Technologies Co., Ltd., Shenzhen (CN)

(72) Inventors: Stefano Sabatini, Boulogne Billancourt (FR); Moussab Bennehar, Boulogne Billancourt (FR); Nathan Piasco, Boulogne Billancourt (CN); Dzmitry Tsishkou, Boulogne Billancourt (FR)

(73) Assignee: Shenzhen Yinwang Intelligent Technologies Co., Ltd., Shenzhen (CN)

(21) Appl. No.: 19/025,193

(22) Filed: Jan. 16, 2025

Related U.S. Application Data
(63) Continuation of application No. PCT/EP2022/072639, filed on Aug. 12, 2022.

(51) Int. Cl. G01S 7/497; G01S 7/48; G01S 17/86; G01S 17/931; G06T 7/70; G06V 10/82

(52) U.S. Cl. CPC G01S 7/4972; G01S 7/4808; G01S 17/86; G01S 17/931; G06T 7/70; G06V 10/82; G06T 2207/10028; G06T 2207/20081; G06T 2207/20084

(57) ABSTRACT

A method of spatially calibrating a LIDAR device with respect to at least one camera device based on one or more simulated LIDAR point clouds. The method comprises the steps of capturing by the at least one camera device at least one image of an environment of the at least one camera device and obtaining a point cloud for the environment by the LIDAR device. The method, furthermore, comprises inputting data based on the at least one captured image into a neural network, outputting by the neural network a neural network representation of the environment of the at least one camera based on the input data, obtaining a first simulated LIDAR point cloud based on the neural network representation and calibrating the LIDAR device by matching of the point cloud obtained by the LIDAR device and the first simulated LIDAR point cloud.

### CROSS-REFERENCE TO RELATED APPLICATIONS

This application is a continuation of International Application No. PCT/EP2022/072639, filed on Aug. 12, 2022, the disclosure of which is hereby incorporated by reference in its entirety.

### TECHNICAL FIELD

The present disclosure relates to a LIDAR-camera system and, in particular, the spatial calibration of a LIDAR device with respect to a camera device.

### BACKGROUND

LIDAR-camera sensing systems comprising one or more Light Detection and Ranging, LIDAR, device(s) configured for obtaining a temporal sequence of 3D point cloud data sets for sensed objects and one or more camera devices configured for capturing a temporal sequence of 2D images of the objects are employed in a variety of applications. For example, vehicles such as automobiles, Automated Guided Vehicles (AGV) and autonomous mobile robots can be equipped with such LIDAR-camera sensing systems to facilitate navigation, localization and obstacle avoidance. In the automotive context, the LIDAR-camera sensing systems can be comprised by Advanced Driver Assistant Systems (ADAS).

Each of the LIDAR device and the camera device reports information with respect to its own local coordinate system. For correct operation of the LIDAR-camera system accurate spatial calibration of the LIDAR device(s) and the camera device(s) with respect to each other is needed, i.e., the rotation (tensor) R and translation (tensor) T representing the spatial relationship between the LIDAR device and the camera device have to be determined accurately.

This calibration poses a severe problem that is conventionally addressed by performing experiments after installment of the LIDAR-camera system. These experiments are based on the sensing of specific targets (checkboards) visible by both kinds of sensor devices. Features like corners and edges can be extracted from point clouds and images of the well-known target (checkboard) and can be used in an optimization procedure that is employed to find the spatial calibration between the two kinds of sensor devices that enables matching of the features. However, such experiments are laborious and time-consuming and have to be carefully performed by specialists.

### SUMMARY

In view of the above, it is an objective underlying the present application to provide a technique for accurate spatial LIDAR-camera calibration at low costs and with a high reliability.

The foregoing and other objectives are achieved by the subject matter of the independent claims. Further implementation forms are apparent from the dependent claims, the description and the figures.

According to a first aspect, it is provided a method of spatially calibrating a Light Detection and Ranging, LIDAR, device with respect to at least one camera device of a LIDAR-camera system. Here, and in the following the term “LIDAR-camera system” refers to a system that comprises a least one LIDAR device and at least one camera device. The method according to the first aspect comprises the steps of capturing by the at least one camera device at least one image of an environment of the at least one camera device and obtaining a point cloud (or LIDAR point cloud, the terms are used interchangeably herein) for the environment by the LIDAR device. The method, furthermore, comprises inputting data based on the at least one captured image into a neural network, outputting by the neural network a neural network representation of the environment of the at least one camera based on the input data, obtaining a first simulated LIDAR point cloud based on the neural network representation of the environment and calibrating the LIDAR device by matching of the point cloud obtained by the LIDAR device and the first simulated LIDAR point cloud. The first simulated LIDAR point cloud may be obtained by simulating LIDAR rays.

The neural network representation of the environment comprises information on the pose(s) of the camera device(s) that is also comprised in the first simulated LIDAR point cloud that is obtained based on this neural network representation. Therefore, matching the real LIDAR point cloud obtained by the LIDAR device with the simulated one allows for spatial calibration of the LIDAR-camera system (see also detailed description below). According to the first aspect and contrary to the art the spatial calibration of the LIDAR device with respect to the camera device is based on a simulated LIDAR point cloud obtained based on a neural network representation of an environment of the LIDAR device and the camera device without any need for performing laborious experiments by human experts for calibration after installment of the LIDAR-camera system.

The spatial calibration of the LIDAR device can be performed automatically after installment of the LIDAR-camera system In particular, LIDAR device may be spatially calibrated with respect to a plurality of camera devices and a plurality of LIDAR devices may be spatially calibrated with respect to the at least one camera device. Further, a plurality of images captured by one or more camera devices (for example, captured at different times, see description below) may be used for deriving the data that is input into the neural network (it goes without saying that herein the term “neural network” refers to an artificial neural network). Moreover, the calibration process may additionally performed based on another point cloud obtained by the LIDAR device.

According to an implementation, the neural network comprises a (deep) Multilayer Perceptron, MLP, (fully connected feedforward neural network) and, in this case, the method according to the first aspect further comprises training the MLP to output spatially-dependent volumetric density values for the environment. Other kinds of neural networks (for example, recurrent or convolutional neural networks) may be used to obtain spatially-dependent volumetric density values. The first simulated LIDAR point cloud may be obtained by simulating LIDAR rays based on the volumetric density values. The neural network representation of the environment comprises such spatially-dependent volumetric density values according to this implementation. MLPs represent efficiently operating fully connected neural networks. Spatially-dependent volumetric density values may suitably be used for simulating the first LIDAR point cloud by simulating LIDAR rays as will be described below.

According to a particular implementation, the MLP is trained based on the Neural Radiance Field (NERF) technique as proposed by B. Mildenhall et al. in a paper, entitled “Nerf: Representing scenes as neural radiance fields for view synthesis” in “Computer Vision-ECCV 2020”, 16^{th} European Conference, Glasgow, UK, Aug. 23-28, 2020, Springer, Cham, 2020. NERF allows for obtaining a neural network representation of the environment based on spatially-dependent volumetric density values that may prove particularly suitable for the simulation of the first LIDAR point cloud and, thus, the spatial calibration of the LIDAR-camera system. It is noted that application of the NERF technique demands for providing a plurality of images captured by the at least one camera device (usually more than one camera device).

When the spatially-dependent volumetric density values are provided by the neural network virtual LIDAR rays (similar to camera rays used for conventional image volume rendering; see also the above cited paper by B. Mildenhall et al.) may be used for simulating the first LIDAR point cloud. Thus, according to another implementation, for each of virtual (simulated) LIDAR rays the accumulated transmittance along the virtual LIDAR ray is determined based on the spatially-dependent volumetric density values and the first simulated LIDAR point cloud is obtained based on the determined accumulated transmittances. In this context, the accumulated transmittances are used to determine the depths (lengths) of the simulated rays in their respective travelling directions. Based on the accumulated transmittances a LIDAR point cloud can be obtained that realistically virtually represents the environment of the LIDAR-camera system.

According to another implementation, the rotation R and translation T of the LIDAR device with respect to the at least one camera device are estimated before obtaining the first simulated LIDAR point cloud and the first simulated LIDAR point cloud is obtained using the estimated rotation and estimated translation of the LIDAR device with respect to the at least one camera device. The spatial calibration of the LIDAR device comprises obtaining a first corrected rotation and a first corrected translation of the LIDAR device with respect to the at least one camera device based on the matching of the point cloud provided by the LIDAR device and the first simulated LIDAR point cloud. Further, a second simulated LIDAR point cloud different from the first simulated LIDAR point cloud is obtained using the first corrected rotation and the first corrected translation of the LIDAR device with respect to the at least one camera device. Subsequently, the point cloud provided by the LIDAR device and the second simulated LIDAR point cloud are matched with each other and an even more accurate second corrected rotation and/or an even more accurate second corrected translation of the LIDAR device with respect to the at least one camera device is obtained based on this matching of the point cloud provided by the LIDAR device and the second simulated LIDAR point cloud with each other.

This procedure of correcting rotation and translation of the LIDAR device with respect to the at least one camera device based on a matching of the LIDAR point cloud provided by the LIDAR device with a respective simulated LIDAR point cloud and simulating a new LIDAR point cloud based on the correction can iteratively be performed until a desired accuracy of the calibration is achieved. For example, the iteration stops when the difference between a particular corrected rotation and/or translation and the rotation and/or translation obtained directly before the particular corrected rotation and/or translation drops below some predefined threshold. Thus, a large series of simulated LIDAR point clouds obtained based on images captured by the one or more cameras can be generated and used for high-accuracy spatial calibration of the LIDAR-camera system.

According to an implementation, the matching steps described above are performed by employing an Iterative Closest Point Algorithm (ICP) that allows for fast and reliable iterative matching of captured LIDAR point cloud with the simulated LIDAR point clouds. According to a particular implementation, the Scale-Adaptive Iterative Closest Point Algorithm (see Y. Sahillioğlu and L. Kavan “Scale-Adaptive ICP” Graphical Models 116 (2021): 101113) is employed for the matching procedures. High accuracy matching can be achieved by means of the Scale-Adaptive ICP that, generally, takes into account different scales (measurement units) of input data of objects that differ by rigid transformations from each other and are to be aligned.

According to a further implementation, the method according to the first aspect or any implementation thereof comprises capturing a plurality of first images of the environment of the at least one camera devices by one of the at least one camera devices, capturing a plurality of second images of the environment of the at least one camera device by another one of the at least one camera devices and inputting data based on the plurality of first captured image and the plurality of second captured images into the neural network. In this implementation, the neural network representation of the environment of the LIDAR-camera system is obtained by the neural network based on the input data based on the plurality of first captured image and the plurality of second captured images. The images of the plurality of first images are captured at different times and the images of the plurality of second images are also captured at different times. By using two or more camera devices each providing a plurality of images a very accurate neural network representation of the LIDAR-camera system can be provided.

The method according to the first aspect or any implementation thereof can suitably be used for the calibration of mobile LIDAR-camera systems. According to another implementation, the LIDAR device and the at least one camera device are installed in a vehicle, for example, an automobile, autonomous mobile robot or Automated Guided Vehicle (AGV). According to a particular implementation, the method according to the first aspect or any implementation thereof is performed during movement of the vehicle. For example, after installment of the LIDAR-camera system an automobile is driven by a driver and during the travel the LIDAR-camera system is automatically spatially calibrated with no need for any interaction by the driver or a human expert. The LIDAR-camera system may be temporally calibrated in order to account for different frame rate of the LIDAR device as compared to the frame rates of the at least one camera device. In automotive applications LIDAR-camera systems have to be reliably and accurately calibrated and the application of the method according to the first aspect or any implementation thereof provides for the needed reliable and accurate calibration.

According to a second aspect, it is provided a computer program product comprising computer readable instructions for, when run on a computer, performing the steps of the method according to the method according to the first aspect or any implementation thereof including controlling capturing processes of the LIDAR and camera devices.

According to a third aspect, it is provided a Light Detection and Ranging, LIDAR,—camera system comprising at least one camera device configured to capture at least one image of an environment of the at least one camera device, a LIDAR device configured to obtain a point cloud for the environment, a neural network configured to obtain a neural network representation of the environment of the at least one camera device based on input data provided based on the at least one captured image and a processing unit. The processing unit is configured to obtain a first simulated LIDAR point cloud based on the neural network representation and calibrate the LIDAR device by matching of the point cloud obtained by the LIDAR device and the first simulated LIDAR point cloud.

The LIDAR-camera system according to the third aspect and the implementations of the same described below provide the same or similar advantages as the ones described above with reference to the method according to the first aspect and the implementations thereof. The LIDAR-camera system according to the third aspect and the implementations of the same may be configured to perform the method according to the third aspect as well as the implementations thereof.

According to an implementation of the third aspect, the neural network of the LIDAR-camera system comprises a Multilayer Perceptron, MLP. According to a further implementation, the MLP is trained to output spatially-dependent volumetric density values for the environment. According to another implementation, the MLP is trained based on the Neural Radiance Field technique.

According to another implementation, the processing unit of the LIDAR-camera system is further configured to estimate the rotation and translation of the LIDAR device with respect to the at least one camera device before the obtaining of the first simulated LIDAR point cloud and to obtain the first simulated LIDAR point cloud based on the estimated rotation and translation of the LIDAR device with respect to the at least one camera device. According to this implementation, the processing unit is further configured to calibrate the LIDAR device by a) obtaining a first corrected rotation and a first corrected translation of the LIDAR device with respect to the at least one camera device based on the matching of the point cloud obtained by the LIDAR device and the first simulated LIDAR point cloud, b) obtaining a second simulated LIDAR point cloud based on the first corrected rotation and first corrected translation of the LIDAR device with respect to the at least one camera device, c) matching the point cloud obtained by the LIDAR device and the second simulated LIDAR point cloud with each other and d) obtaining a more accurate second corrected rotation and a more accurate second corrected translation of the LIDAR device with respect to the at least one camera device based on this matching of the point cloud and the second simulated LIDAR point cloud.

According to a fourth aspect, it is provided a vehicle comprising the LIDAR-camera system according to the third aspect or any implementation of the same. The vehicle may be an automobile, an autonomous mobile robot or an Automated Guided Vehicle (AGV).

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 is a flow chart illustrating a method of spatially calibrating a LIDAR device with respect to one or more camera devices according to an embodiment.

FIG. 2 illustrates a LIDAR-camera system according to an embodiment.

FIG. 3 illustrates spatial calibration of a LIDAR device with respect to camera devices based on NERF.

FIG. 4 illustrates determination of accumulated transmittances used for obtaining a simulated LIDAR point cloud according to an embodiment.

FIG. 5 illustrates spatial calibration of a LIDAR device with respect to camera devices based on iterative matching of simulated LIDAR point clouds with a point cloud obtained by the LIDAR device.

FIG. 6 is a flow chart illustrating a method of spatially calibrating a LIDAR device with respect to camera devices based on iterative simulation of LIDAR rays according to an embodiment.

### DETAILED DESCRIPTION OF THE EMBODIMENTS

Herein, it is provided a method of automatically spatially calibrating a LIDAR device with respect to at least one camera device and a LIDAR-camera system that can be calibrated by such a method. The spatial calibration is based on simulated LIDAR point clouds and the simulation of the LIDAR point clouds is based on a neural network representation of the environment of the LIDAR-camera system that is obtained by a neural network based on images captured by the at least one camera device.

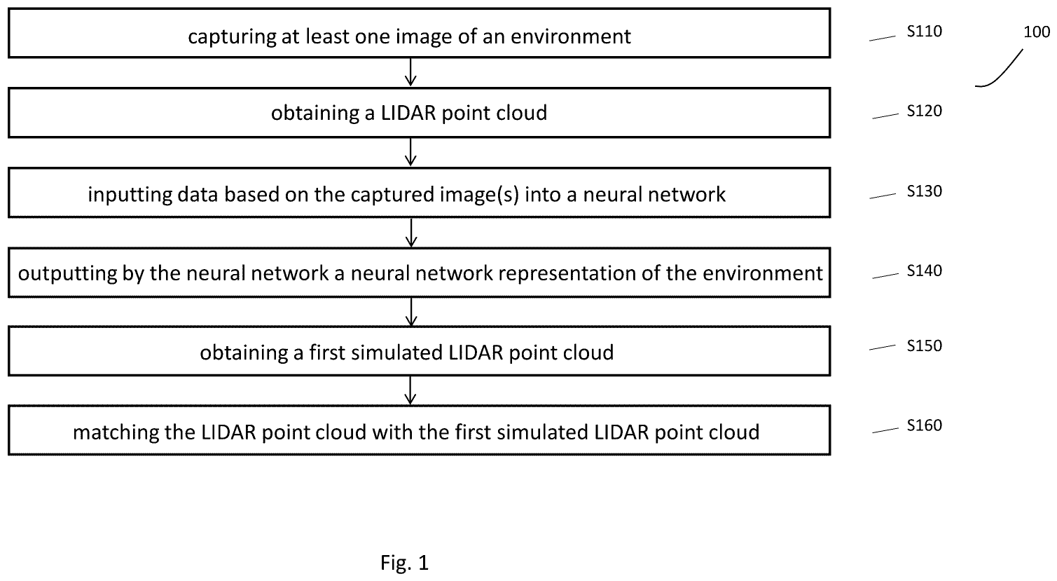

An embodiment of the method 100 of spatially calibrating a LIDAR device with respect to at least one camera device is illustrated in FIG. 1. The aim of the calibration is to accurately determine the translation (matrix) T and rotation (matrix) R of the LIDAR device with respect to the at least one camera device after installment of the LIDAR-camera system. One or more 2D pictures of an environment of the at least one camera are captured S110 by the at least one camera device. The pose of the least one camera when capturing the one or more 2D pictures is exactly known. A 3D LIDAR point cloud S120 is obtained by the LIDAR device.

Data based on the one or more captured images is input S130 into a neural network. The input may comprise a tensor with the shape (number of images)×(image width)×(image height)×(image depth). For the first layer of the neural network which process input data the number of input channels may be equal to or larger than the number of channels of data representation, for instance 3 channels for RGB or YUV representation of the images. By passing a neural network layer the image may become abstracted to a feature map, with shape (number of images)×(feature map width)×(feature map height)×(feature map channels) and further processed.

The neural network outputs S140 a neural network representation of the environment represented by the captured image(s). The neural network representation of the environment may give information on the volumetric density of the environment captured by the one or more cameras for each point in 3D space.

A first simulated LIDAR point cloud is obtained S150 based on the neural network representation of the environment. Since the specification of the LIDAR device, for example, the number of layers, resolutions and vertical field of view, are known it is possible to simulate LIDAR point clouds from various possible positions. This may be done by evaluating the neural network representation of the environment along the LiDAR rays through a ray marching procedure (see description below). The first simulated LIDAR point cloud is obtained based on a first guess for the translation T and rotation R of the LIDAR device with respect to the one or more camera devices.

The LIDAR point cloud is matched S160 with the first simulated LIDAR point cloud. Translation T and rotation R of the LIDAR device with respect to the one or more camera devices can be determined based on the best matching score between the LIDAR point cloud and the first simulated LIDAR point cloud. According to an embodiment, based on the thus obtained translation T and rotation R a second simulated LIDAR point cloud can be obtained for the neural network representation of the environment and a second matching process results in corrected translation T and rotation R. This process of obtaining corrected translation T and rotation R and simulating a LIDAR point cloud based on the corrected translation T and rotation R can be iterated until a desired accuracy of the translation T and rotation R of the LIDAR device with respect to the one or more camera devices is achieved and, thus, the spatial calibration process is completed. It is noted that the calibration process may additionally performed for another point cloud obtained by the LIDAR device and final calibration may be based on the results of the calibration process based on the point cloud obtained by the LIDAR device and the other point cloud obtained by the LIDAR device.

The translation T and rotation R represent a rigid spatial transformation between a coordinate systems centered on the LIDAR device and a coordinate systems centered on the camera device. Translation can include three translational movements in three perpendicular axes x, y, and z. Rotation can include three rotational movements, i.e., roll, yaw and pitch, about the three perpendicular axes x, y, and z. Transformation of the coordinates from one of the coordinate systems to the other can be obtained by matrix multiplication.

Using, for example, a calibrated pinhole camera model that is commonly used in computer vision, pixel coordinates (u, v) of the projection of a 3D point, with its 3D coordinates expressed in its own coordinate system, are obtained by multiplying the 3D coordinates of this point expressed in a camera coordinate system (lower index K) by the so called camera intrinsic matrix K (where fₓ, f_{y} correspond to the focal length of the camera in pixel units, wherein fₓ=f_{y} holds for square pixels cameras, and u₀, v₀ denote the projection of the optical center of the camera on the image plane):

$$( \begin{matrix}u \\ v \\ 1\end{matrix} ) = ( \begin{matrix}k u \\ k v \\ k\end{matrix} ) = K ( \begin{matrix}{X}_{C} \\ {Y}_{C} \\ {Z}_{C}\end{matrix} ) = ( \begin{matrix}{f}_{x} & 0 & {u}_{0} \\ 0 & {f}_{y} & {v}_{0} \\ 0 & 0 & 1\end{matrix} ) ( \begin{matrix}{X}_{C} \\ {Y}_{C} \\ {Z}_{C}\end{matrix} ) = ( \begin{matrix}{f}_{x} & 0 & {u}_{0} \\ 0 & {f}_{y} & {v}_{0} \\ 0 & 0 & 1\end{matrix} ) ( \begin{matrix}R & T \\ 0 & 1\end{matrix} ) ( \begin{matrix}{X}_{L} \\ {Y}_{L} \\ {Z}_{L}\end{matrix} )$$

where the lower index L denotes the LIDAR coordinate system and R and T denote the rotation and translation from the LIDAR coordinate system with respect to the camera coordinate system.

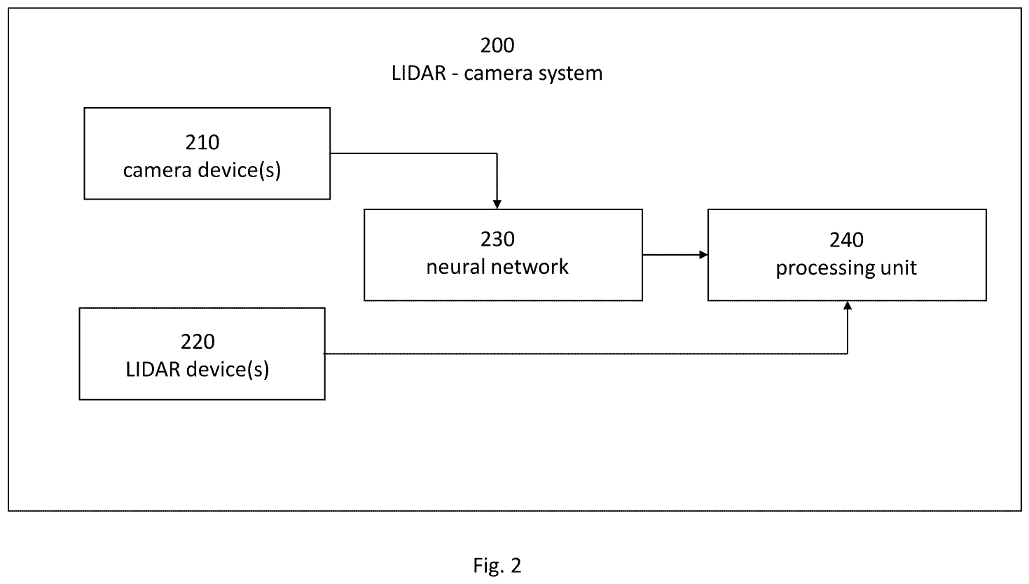

The method 100 illustrated in FIG. 1 allows for automatic spatial calibration of a LIDAR-camera system. It can be implemented, for example, in the LIDAR-camera system 200 illustrated in FIG. 2. The LIDAR-camera system 200 illustrated in FIG. 2 comprises one or more camera device 210 and one or more LIDAR devices 220 that are to be spatially calibrated with the one or more camera device 210. Further, the LIDAR-camera system 200 comprises a neural network 230 (for example, being or comprising a Multilayer Perceptron, MLP, or fully connected feedforward neural network, both terms are used interchangeably herein) and a processing unit 240. Data based on images of an environment of the one or more camera device 210 is input into neural network 230 that is trained for outputting a neural network representation of the environment.

The neural network representation of the environment is input into the processing unit 240. A LIDAR point cloud obtained by the LIDAR device 210 is also input into the processing unit 240. The processing unit 240 is configured to obtain a simulated LIDAR point cloud based on the neural network representation of the environment output by the neural network 220 and to match the (real) LIDAR point cloud obtained by the LIDAR device 210 with the simulated LIDAR point cloud in order to spatially calibrate the LIDAR-camera system 200. The processing unit 240 may be configured to perform the steps S150 and S160 of the method 100 illustrated in FIG. 1.

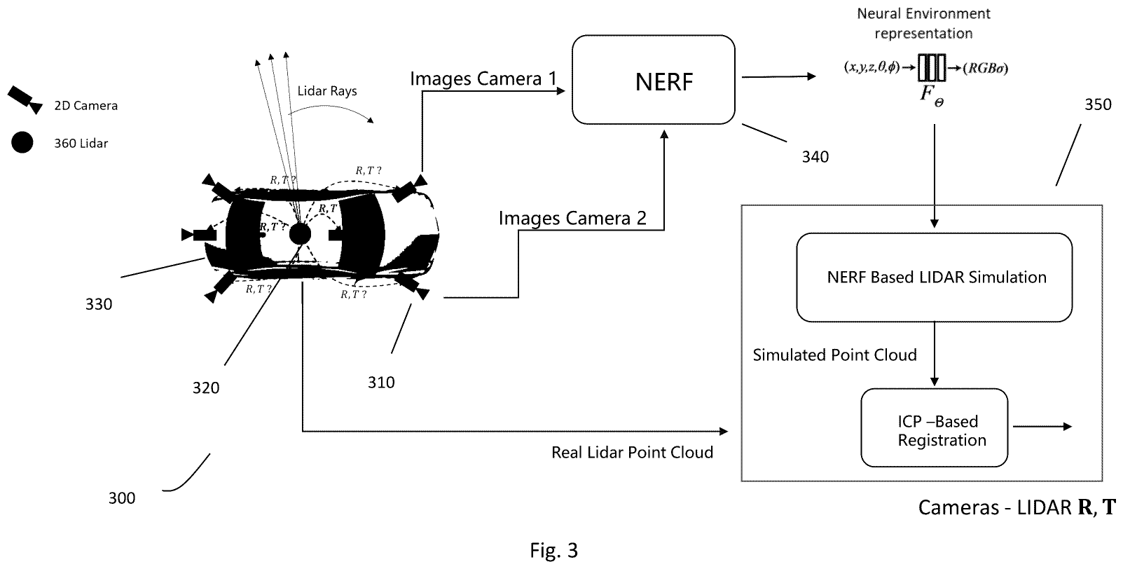

A particular embodiment of spatial calibration of a LIDAR-camera system 300 is illustrated in FIG. 3. The LIDAR-camera system 300 comprises a plurality of camera devices 310 and a LIDAR device 320 installed in a vehicle 330. The following description is not restricted, however, to any number of cameras or installment of the LIDAR-camera system 300 that is to be calibrated in a vehicle 330. The LIDAR device 320 is to be spatially calibrated with respect to each of the camera devices 310, i.e., the respective translations T and rotations R of the LIDAR device 320 with respect to all of the camera devices 310 are to be determined. The calibration process can be run in the background, for example, while the vehicle is moving. In the following, spatial calibration of the LIDAR device 320 with respect to two front cameras of the camera devices 310 is described, for example.

Each of the two front camera devices 310 captures a plurality of images of the environment (drive scene) within a particular range of, for example, 50 meters. For example, a temporal sequence of images is captured by the two front camera devices 310 with a recording frame rate of about 30 Hz, for example. The LIDAR device 320 obtains 3D point clouds representing the environment with a recording frame rate of about 30 Hz, for example. The LIDAR device 320 and the camera devices 310 may be temporally calibrated with respect to each other.

Data based on the captured images is input into a Neural Radiance Field (NERF) trained neural network 340 comprising or consisting of an MLP. The input data represents coordinates (x, y, z) of a sampled set of 3D points and the viewing directions (θ, φ) corresponding to the 3D points and the NERF trained neural network 340 outputs view dependent color values (for example RGB) and volumetric density values σ (cf. paper by B. Mildenhall et al. cited above). Thus, the MLP realizes F_{Θ}: (x, y, z, θ, σ)→(R, G, B, ϵ) with optimized weights Θ obtained during the training.

The LIDAR-camera system 300 further comprises a processing unit 350 configured for performing the spatial calibration based on the output of the NERF trained neural network 340. The processing unit 350 receives a LIDAR point cloud obtained by the LIDAR device 320. The LIDAR point cloud received by the processing unit 350 may temporarily correspond to a particular one of the images captured by one of the two front camera devices 310 and/or a particular one of the images captured by the other one of the two front camera devices 310.

Based on the output of the NERF trained neural network 340 representing a neural network representation of the environment the processing unit 350 simulates a LIDAR point cloud and matches the simulated LIDAR point cloud with the LIDAR point cloud obtained by the LIDAR device 320.

An Iterative Closest Point Algorithm (ICP) is used for registering the point clouds with respect to each other. For example, a scale-adaptive ICP algorithm can be employed that takes into account different scales of the point cloud obtained by the LIDAR device 320 and the simulated point cloud. Comparison of the camera-based and NERF based simulated LIDAR point cloud and the real LIDAR point cloud obtained by the LIDAR device 320 allows determining the spatial relationship between the LIDAR device 320 and the camera devices 310.

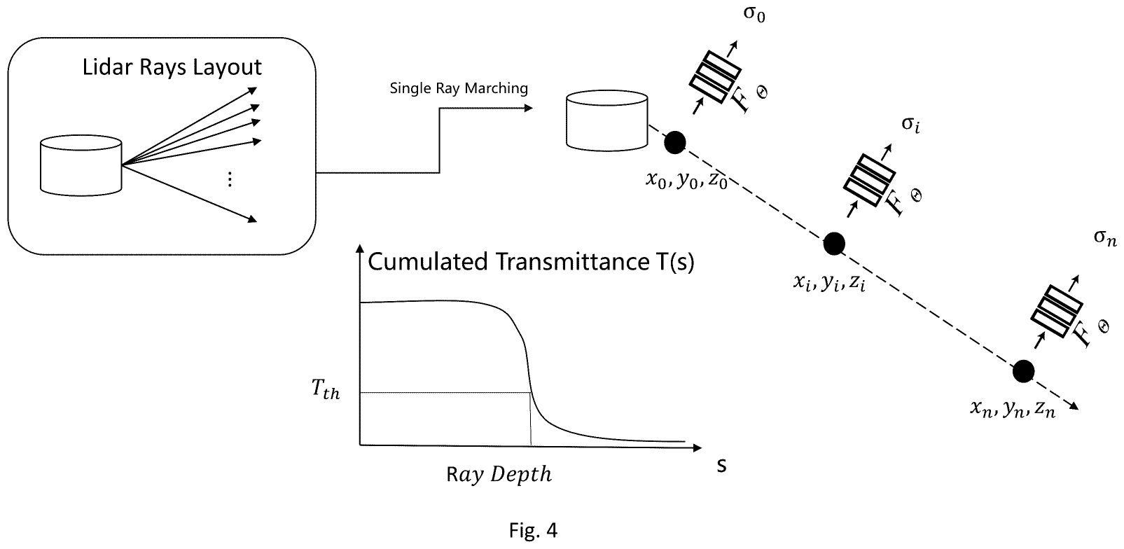

The process of simulating a LIDAR point cloud based on the output of the NERF trained neural network 340 is illustrated in FIG. 4. Since the specification of the LIDAR device 320 (vertical FOV, number of layers and horizontal angular resolution) is known, the direction of each single LIDAR ray is also known for a given pose of the LIDAR device 320 (and thus a particular translation T and rotation R). For each LIDAR ray (trace) the volumetric density values σ (of the neural network representation of the environment output by the NERF trained neural network 340) are evaluated on for example, evenly spaced, 3D locations along the ray direction.

The volumetric density σ(x, y, z) can be interpreted as the differential probability of a ray terminating at an infinitesimal particle at (x, y, z). By gathering all the volumetric density values along the ray direction, the accumulated transmittance T(s) along the ray direction can be computed T(s)=exp(−∫₀^{s}σ(r(l))dl (see FIG. 4). The accumulated transmittance T(s) along the ray from its origin 0 to s represents the probability that the ray travels its path to s without hitting any particle. For a given simulated LIDAR ray, the actual accumulated transmittance as a function of the distance from the origin 0 is permanently compared with some predefined threshold Tₜₕ and when the accumulated transmittance T along the ray direction falls below the predefined threshold Tₜₕ the corresponding travelled distance s is determined as the ray depth (length). Simulating all of the LIDAR rays in this manner results in a simulated 3D point cloud.

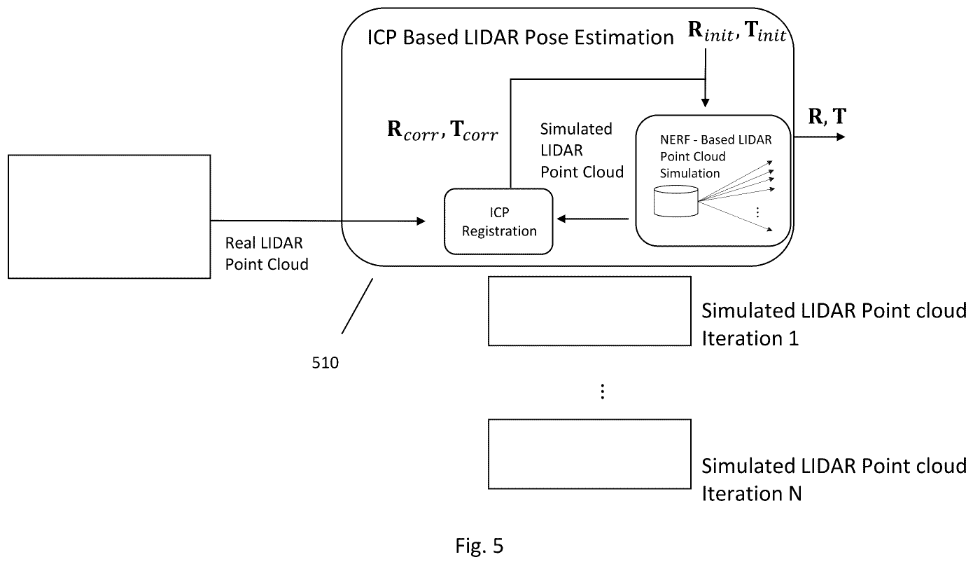

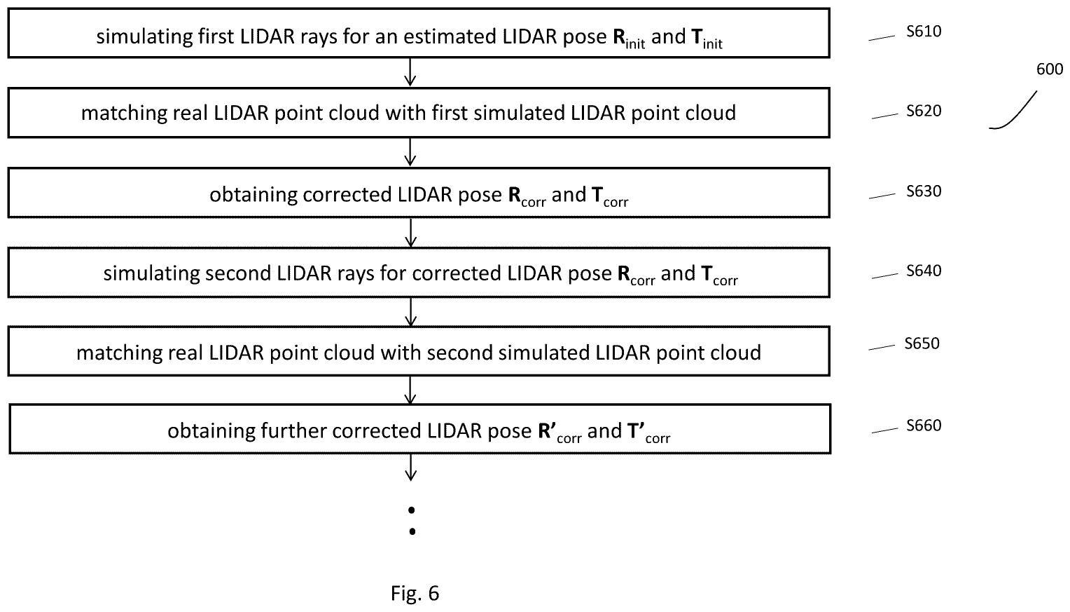

According to this embodiment, the spatial calibration of the LIDAR-camera system makes use of matching of the real LIDAR point cloud obtained by the LIDAR device 320 and iteratively simulated LIDAR point clouds as it is illustrated in FIGS. 5 and 6. As already mentioned the matching of the real LIDAR point cloud and a particular one of the simulated LIDAR point clouds can be performed by an ICP algorithm, for example, a scale-adaptive ICP algorithm. This kind of iteration performed based on a best matching score of matching the point clouds is different from the iteration of the simulation of LIDAR point clouds.

As shown in FIG. 5, a processing unit 510 (for example, the same as the processing unit 240 shown in FIG. 2) receives a real LIDAR point cloud obtained by a LIDAR device (for example, the LIDAR device 320 shown in FIG. 3). The processing unit 510 is configured to perform the method 600 illustrated in FIG. 6. According to the method 600 illustrated in FIG. 6 iteration of the simulation of LIDAR point clouds starts with simulating S610 LIDAR rays for an initial estimated pose of the LIDAR device 320 with respect to the two front camera 310 given by Rᵢₙᵢₜ and Tᵢₙᵢₜ as estimates of the sought accurate calibration values of the rotation R and translation T of the LIDAR device 320 with respect to the two front camera devices 310. The initial estimates Rᵢₙᵢₜ and Tᵢₙᵢₜ can be suitably chosen depending on the actually installed configuration of the LIDAR-camera system.

A first simulated LIDAR point cloud is obtained by simulating S610 first LIDAR rays as described above with a pose given by Rᵢₙᵢₜ and Tᵢₙᵢₜ. This pose defines origin and direction of the first simulated LIDAR rays. The real LIDAR point cloud obtained by the LIDAR device 320 is matched/registered S620 with the first simulated LIDAR point cloud (using the ICP algorithm). The best matching score corresponds to a corrected pose given by R_{corr} and T_{corr} obtained S630 by the matching process (see also FIG. 5). The corrected rotation R_{corr} and translation T_{corr} are used for a second simulation S640 of the LIDAR rays with origins and directions defined by R_{corr} and T_{corr}. The real LIDAR point cloud obtained by the LIDAR device 320 is matched S650 with the thus obtained second simulated LIDAR point cloud. A further corrected even more accurate pose given by the rotation R′_{corr} and the translation T′_{corr} is obtained S660 by the matching process and can be used for a third simulation of the LIDAR rays with origins and directions defined by these further corrected rotation R′_{corr} and translation T′_{corr}. This iterative simulation can be continued until a desired accuracy of the calibration is achieved, for example, when differences between actually achieved R′_{corr} and T′_{corr} and R′_{corr} and T′_{corr} achieved in the directly preceding iteration step fall below some predefined threshold(s).

Each of the iteratively simulated LIDAR point clouds is simulated based on the same neural network representation of the environment. Since the LIDAR rays can be simulated from any 3D position in the space, whenever the R, T matrixes are refined, a new virtual Lidar point cloud can be (re-) simulated. Thereby, convergence towards accurate calibration values is accelerated, because from one iteration to another new parts of the 3D space can be covered.

All previously discussed embodiments are not intended as limitations but serve as examples illustrating features and advantages of the invention. It is to be understood that some or all of the above-described features can also be combined in different ways.

What is claimed is:

1. Method of spatially calibrating a Light Detection and Ranging, LIDAR, device with respect to at least one camera device, comprising the steps of
capturing by the at least one camera device at least one image of an environment of the at least one camera device;
obtaining a point cloud for the environment by the LIDAR device;
inputting data based on the at least one captured image into a neural network (230, 340);
outputting by the neural network a neural network representation of the environment of the at least one camera based on the input data;
obtaining a first simulated LIDAR point cloud based on the neural network representation; and
calibrating the LIDAR device by matching of the point cloud and the first simulated LIDAR point cloud.

2. The method according to claim 1, wherein the neural network comprises a Multilayer Perceptron, MLP, and further comprising training the MLP to output spatially-dependent volumetric density values for the environment.

3. The method according to claim 2, wherein the MLP is trained based on the Neural Radiance Field technique.

4. The method according to claim 2, further comprising determining for each of virtual LIDAR rays the accumulated transmittance along the virtual LIDAR ray based on the spatially-dependent volumetric density values, and wherein the first simulated LIDAR point cloud is obtained based on the determined accumulated transmittances.

5. The method according to claim 1, further comprising
estimating a rotation and translation of the LIDAR device with respect to the at least one camera device before the obtaining the first simulated LIDAR point cloud; and wherein
the first simulated LIDAR point cloud is obtained using the estimated rotation and estimated translation of the LIDAR device with respect to the at least one camera device; and
the calibrating of the LIDAR device comprises
a) obtaining a first corrected rotation and a first corrected translation of the LIDAR device with respect to the at least one camera device based on the matching of the point cloud and the first simulated LIDAR point cloud;
b) obtaining a second simulated LIDAR point cloud different from the first simulated LIDAR point cloud using the first corrected rotation and the first corrected translation of the LIDAR device with respect to the at least one camera device; and
c) matching the point cloud and the second simulated LIDAR point cloud with each other; and
d) obtaining a more accurate second corrected rotation and a more accurate second corrected translation of the LIDAR device with respect to the at least one camera device based on the matching.

6. The method according to claim 5, wherein the steps a) and c) are performed by employing an Iterative Closest Point Algorithm.

7. The method according to claim 6, wherein the Iterative Closest Point Algorithm is the Scale-Adaptive Iterative Closest Point Algorithm.

8. The method according to claim 1, comprising capturing a plurality of first images of the environment of the at least one camera devices by one of the at least one camera devices;
capturing a plurality of second images of the environment of the at least one camera device by another one of the at least one camera devices; and
inputting data based on the plurality of first captured image and the plurality of second captured images into the neural network;
and wherein
the neural network representation is obtained by the neural network based on the input data based on the plurality of first captured image and the plurality of second captured images.

9. The method according to claim 1, wherein the LIDAR device and the at least one camera device are installed on a vehicle.

10. The method according to claim 9, wherein the method is performed during movement of the vehicle.

11. A computer program product comprising computer readable instructions for, when run on a computer, performing the steps of the method according to claim 1.

12. Light Detection and Ranging, LIDAR,—camera system, comprising
at least one camera device configured to capture at least one image of an environment of the at least one camera device;
a LIDAR device configured to obtain a point cloud for the environment;
a neural network configured to obtain a neural network representation of the environment of the at least one camera device based on input data provided based on the at least one captured image; and
a processing unit configured to
obtain a first simulated LIDAR point cloud based on the neural network representation; and
calibrate the LIDAR device by matching of the point cloud and the first simulated LIDAR point cloud.

13. The LIDAR-camera system according to claim 12, wherein the neural network comprises a Multilayer Perceptron, MLP.

14. The LIDAR-camera system according to claim 13, wherein the MLP is trained to output spatially-dependent volumetric density values for the environment.

15. The LIDAR-camera system according to claim 14, wherein the MLP is trained based on the Neural Radiance Field technique.

16. The LIDAR-camera system according to claim 12, wherein the processing unit is further configured to
estimate a rotation and translation of the LIDAR device with respect to the at least one camera device before the obtaining of the first simulated LIDAR point cloud;
obtain the first simulated LIDAR point cloud based on the estimated rotation and translation of the LIDAR device with respect to the at least one camera device; and
calibrate the LIDAR device by
a) obtaining a first corrected rotation and a first corrected translation of the LIDAR device with respect to the at least one camera device based on the matching of the point cloud and the first simulated LIDAR point cloud;
b) obtaining a second simulated LIDAR point cloud based on the first corrected rotation and first corrected translation of the LIDAR device with respect to the at least one camera device;
c) matching the point cloud and the second simulated LIDAR point cloud with each other; and
d) obtaining a more accurate second corrected rotation and a more accurate second corrected translation of the LIDAR device with respect to the at least one camera device based on the matching.

17. Vehicle comprising the LIDAR-camera system according to claim 12.
